(19) United States
(12) Patent Application Publication
(10) Pub. No.: US 2026/0312272 A1
(43) Pub. Date: Oct. 8, 2026

(54) RADIO WAVE CONTROL PLATE

(71) Applicant: KYOCERA Corporation, Kyoto-shi, Kyoto (JP)

(72) Inventors: Masamichi YONEHARA, Yokohama-shi, Kanagawa (JP); Hiromichi YOSHIKAWA, Yokohama-shi, Kanagawa (JP)

(21) Appl. No.: 19/484,249

(22) PCT Filed: May 8, 2024
(86) PCT No.: PCT/JP2024/017182

§ 371 Date: Nov. 13, 2025

(30) Foreign Application Priority Data
May 18, 2023 (JP) 2023-082455

(51) Int. Cl. H01P 7/00; H01Q 9/04

(52) U.S. Cl. CPC H01P 7/00; H01Q 9/0407

(57) ABSTRACT

A radio wave control plate includes a plurality of unit structures arrayed in a first planar direction. Each of the unit structures includes: a plurality of resonators extending in the first planar direction; a coupling conductor configured to adjust a coupling coefficient between the plurality of resonators; and a connecting portion configured to change a structure corresponding to a coupling matrix of the unit structure.

### TECHNICAL FIELD

The present disclosure relates to a radio wave control plate.

### BACKGROUND OF INVENTION

There is known a technique of controlling electromagnetic waves without using a dielectric lens. For example, Patent Document 1 describes a technique of refracting radio waves in a structure including an array of resonator elements by changing parameters of the respective resonator elements.

### Citation List

### Patent Literature

Patent Document 1: JP 2015-231182 A

### SUMMARY

A radio wave control plate according to the present disclosure includes: a plurality of unit structures arrayed in a first planar direction, and each of the unit structures includes a plurality of resonators extending in the first planar direction, a coupling conductor configured to adjust a coupling coefficient between the plurality of resonators, and a connecting portion configured to change a structure corresponding to a coupling matrix of the unit structure.

### BRIEF DESCRIPTION OF THE DRAWINGS

FIG. 1 is a diagram illustrating an overview of a radio wave control plate according to a first embodiment.

FIG. 2 is a diagram illustrating a configuration example of a unit structure according to the first embodiment.

FIG. 3 is a diagram illustrating a configuration example of a resonator according to the first embodiment.

FIG. 4 is a diagram illustrating a configuration example of a reference conductor according to the first embodiment.

FIG. 5 is a diagram illustrating a method of changing a structure based on a coupling matrix of the unit structure according to the first embodiment.

FIG. 6 is a diagram illustrating the configuration example of the reference conductor according to the first embodiment.

FIG. 7 is a diagram illustrating the configuration example of the resonator according to the first embodiment.

FIG. 8 is a diagram showing reflection characteristics and transmission characteristics of the unit structure when a connecting portion of a first reference conductor of the unit structure according to the first embodiment is in a short-circuited state.

FIG. 9 is a diagram showing reflection characteristics and transmission characteristics of the unit structure when the connecting portion of the first reference conductor of the unit structure according to the first embodiment is in an open-circuited state.

FIG. 10 is a diagram illustrating a configuration example of a unit structure according to a second embodiment.

FIG. 11 is a diagram illustrating a configuration example of a resonator according to the second embodiment.

FIG. 12 is a diagram showing reflection characteristics and transmission characteristics of the unit structure according to the second embodiment.

### DESCRIPTION OF EMBODIMENTS

In the following, embodiments of the present invention will be described in detail with reference to the accompanying drawings. The present invention is not limited by the embodiments, and in the following embodiments, the same reference signs are assigned to the same portions and redundant descriptions thereof will be omitted.

In the following description, an XYZ orthogonal coordinate system is set, and the positional relationship between respective portions will be described by referring to the XYZ orthogonal coordinate system. A direction parallel to an X axis in a horizontal plane is defined as an X-axis direction, a direction parallel to a Y axis orthogonal to the X axis in the horizontal plane is defined as a Y-axis direction, and a direction parallel to a Z axis orthogonal to the horizontal plane is defined as a Z-axis direction. A plane including the X-axis and the Y-axis is appropriately referred to as an XY plane, a plane including the X-axis and the Z-axis is appropriately referred to as an XZ plane, and a plane including the Y-axis and the Z-axis is appropriately referred to as a YZ plane. The XY plane is parallel to the horizontal plane. The XY plane, the XZ plane, and the YZ plane are orthogonal to each other.

### First Embodiment

### Radio Wave Control Plate

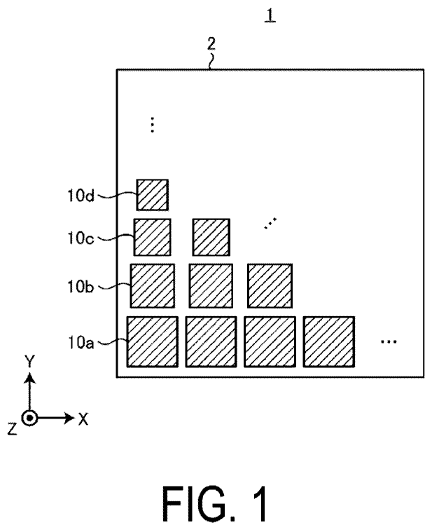

An overview of a radio wave control plate according to the first embodiment will be described with reference to FIG. 1. FIG. 1 is a diagram illustrating the overview of the radio wave control plate according to the first embodiment.

The radio wave control plate 1 is a plate-like member that is reflective or permeable (refractive) to a radio wave transmitted from a base station. The radio wave control plate 1 is configured to, for example, receive the radio wave transmitted from the base station, and reflect or refract the radio wave at a predetermined angle. The radio wave control plate 1 may be made of, for example, a metamaterial that changes the phase of an incident wave.

As illustrated in FIG. 1, the radio wave control plate 1 may include, for example, a substrate 2, unit structures 10a, unit structures 10b, unit structures 10c, and unit structures 10d. When the unit structures 10a to the unit structures 10d do not need to distinguish from each other, they are collectively referred to as a unit structure 10.

The unit structures 10a, the unit structures 10b, the unit structures 10c, and the unit structures 10d may be formed on the substrate 2. The substrate 2 may be, for example, a dielectric substrate made of a dielectric body. The substrate 2 may have a rectangular shape, for example, but is not limited thereto. The unit structures 10a, the unit structures 10b, the unit structures 10c, and the unit structures 10d may be two dimensionally arrayed on the substrate 2.

Specifically, on the substrate 2, a plurality of unit structures 10a may be arranged in a line in the bottom row of the substrate 2. On the substrate 2, a plurality of unit structures 10b may be arranged in a line above the row where the unit structures 10a are arranged. On the substrate 2, a plurality of unit structures 10c may be arranged in a line above the row where the unit structures 10b are arranged. On the substrate 2, a plurality of unit structures 10d may be arranged in a line above the row where the unit structures 10c are arranged. That is, the radio wave control plate 1 may have a structure in which a plurality of unit structures having different sizes are cyclically arrayed. The unit structures 10a to 10d may be different from each other in a frequency band and a change amount in a phase of the radio wave to be changed. The unit structures 10a to 10d have rectangular shapes, but are not limited thereto. The frequency band and the change amount in a phase of the radio wave to be reflected or refracted can be adjusted by varying the sizes and shapes of the unit structure 10a, the unit structure 10b, the unit structure 10c, and the unit structure 10d.

### Unit Structure

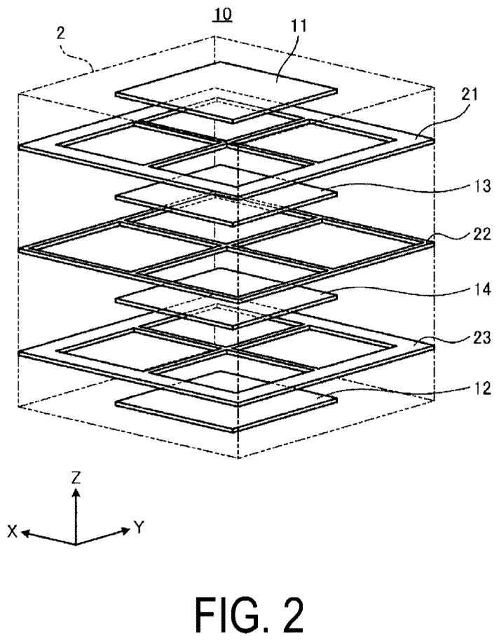

A configuration example of a unit structure according to the first embodiment will be described with reference to FIG. 2. FIG. 2 is a diagram illustrating the configuration example of the unit structure according to the first embodiment.

As illustrated in FIG. 2, the unit structure 10 includes the substrate 2, a first resonator 11, a second resonator 12, a third resonator 13, a fourth resonator 14, a first reference conductor 21, a second reference conductor 22, and a third reference conductor 23. The unit structure 10 has a seven-layer structure in which seven layers of conductors are stacked. In the unit structure 10, the second resonator 12, the third reference conductor 23, the fourth resonator 14, the second reference conductor 22, the third resonator 13, the first reference conductor 21, and the first resonator 11 are stacked in this order from the bottom.

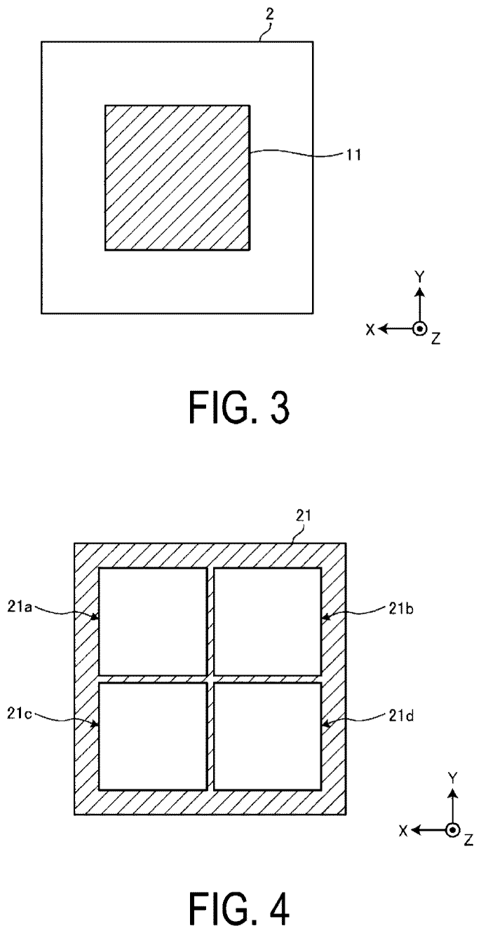

The first resonator 11 is formed in the uppermost layer. The first resonator 11 is made of a conductor. FIG. 3 is a diagram illustrating the configuration example of a resonator according to the first embodiment. As illustrated in FIG. 3, the first resonator 11 extends on the XY plane. The first resonator 11 is formed in, for example, a square patch shape. The size of the first resonator 11 may be changed to any size according to the design.

The first reference conductor 21 is formed in a layer immediately below the first resonator 11. The first reference conductor 21 is made of a conductor. FIG. 4 is a diagram illustrating a configuration example of a reference conductor according to the first embodiment. As illustrated in FIG. 4, the first reference conductor 21 extends on the XY plane. The first reference conductor 21 is formed in a square frame shape. The first reference conductor 21 includes a gap 21a, a gap 21b, a gap 21c, and a gap 21d. The gap 21a is formed, for example, at the upper left corner of the first reference conductor 21. The gap 21b is formed, for example, at the upper right corner of the first reference conductor 21. The gap 21c is formed, for example, at the lower left corner of the first reference conductor 21. The gap 21d is formed, for example, at the lower right corner of the first reference conductor 21. The gap 21a, the gap 21b, the gap 21c, and the gap 21d may be formed in the same square shape, for example. The size of each of the gap 21a to the gap 21d may be changed to any size according to the design.

The third resonator 13 is formed in a layer immediately below the first reference conductor 21. The third resonator 13 is made of a conductor. The third resonator 13 is formed in, for example, the same shape as the first resonator 11. That is, the third resonator 13 extends on the XY plane. The third resonator 13 is formed in, for example, a square patch shape. The third resonator 13 may have a size different from that of the first resonator 11. The size of the third resonator 13 may be changed to any size according to the design. The first resonator 11 and the third resonator 13 are magnetically or capacitively connected to each other via a gap in the first reference conductor 21.

The second reference conductor 22 is formed in a layer immediately below the third resonator 13. The second reference conductor 22 is made of a conductor. The second reference conductor 22 is formed in, for example, the same shape as the first reference conductor 21. That is, the second reference conductor 22 extends on the XY plane. The second reference conductor 22 is formed in a square frame shape. The second reference conductor 22 includes four gaps in the same manner as and/or a similar manner to the first reference conductor 21. The four gaps of the second reference conductor 22 may have a size different from the size of the four gaps of the first reference conductor 21. The size of the four gaps of the second reference conductor 22 may be changed to any size according to the design.

The fourth resonator 14 is formed in a layer immediately below the second reference conductor 22. The fourth resonator 14 is made of a conductor. The fourth resonator 14 is formed in, for example, the same shape as the first resonator 11. That is, the fourth resonator 14 extends on the XY plane. The fourth resonator 14 is formed in a square patch shape. The third resonator 13 and the fourth resonator 14 are magnetically or capacitively connected to each other via the four gaps in the second reference conductor 22.

The third reference conductor 23 is formed in a layer immediately below the fourth resonator 14. The third reference conductor 23 is made of a conductor. The third reference conductor 23 is formed in, for example, the same shape as the first reference conductor 21. That is, the third reference conductor 23 extends on the XY plane. The third reference conductor 23 is formed in a square frame shape. The third reference conductor 23 includes four gaps in the same manner as and/or a similar manner to the first reference conductor 21. The four gaps of the third reference conductor 23 may have a size different from the size of the four gaps of the first reference conductor 21. The size of the four gaps of the third reference conductor 23 may be changed to any size according to the design.

The second resonator 12 is formed in a layer immediately below the third reference conductor 23. The second resonator 12 is made of a conductor. The second resonator 12 is formed in, for example, the same shape as the first resonator 11. That is, the second resonator 12 extends on the XY plane. The second resonator 12 is formed in, for example, a square patch shape. The second resonator 12 and the fourth resonator 14 are magnetically or capacitively connected to each other via the four gaps in the third reference conductor 23.

In the first embodiment, the unit structure 10 can exhibit desired transmission characteristics or reflection characteristics by being designed as appropriate. Specifically, the transmission characteristics or reflection characteristics of the unit structure 10 are characterized by a coupling matrix. Since a structure corresponding to the coupling matrix is available, the unit structure 10 is designed based on the coupling matrix, and thus can have desired transmission characteristics or reflection characteristics. On the other hand, by changing a part of the structure of the unit structure 10, the coupling matrix also changes, and thus the transmission characteristics or the reflection characteristics change. The unit structure 10 is formed such that a structure corresponding to the coupling matrix can be electrically controlled.

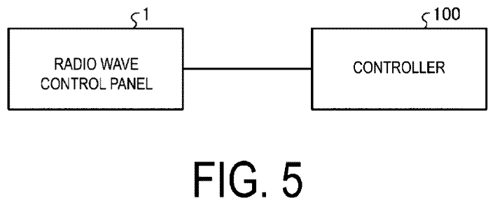

FIG. 5 is a diagram illustrating a method of changing a structure corresponding to the coupling matrix of the unit structure according to the first embodiment. As illustrated in FIG. 5, a controller 100 that changes a structure corresponding to the coupling matrix of the unit structure 10 is connected to the radio wave control plate 1 according to the first embodiment.

The controller 100 includes one or more arithmetic devices. Examples of the arithmetic device include, but are not limited to, a central processing unit (CPU), a system-on-a-chip (SoC), a micro control unit (MCU), a field-programmable gate array (FPGA), and a coprocessor. The controller 100 implements processes related to various operations of the radio wave control plate 1 by causing the arithmetic device to execute a control program.

The unit structure 10 is formed such that the structure corresponding to the coupling matrix can be changed by the controller 100. Specifically, the unit structure 10 is formed such that the number of resonators included in the unit structure 10 can be changed by the controller 100.

### Configuration Example of Reference Conductor

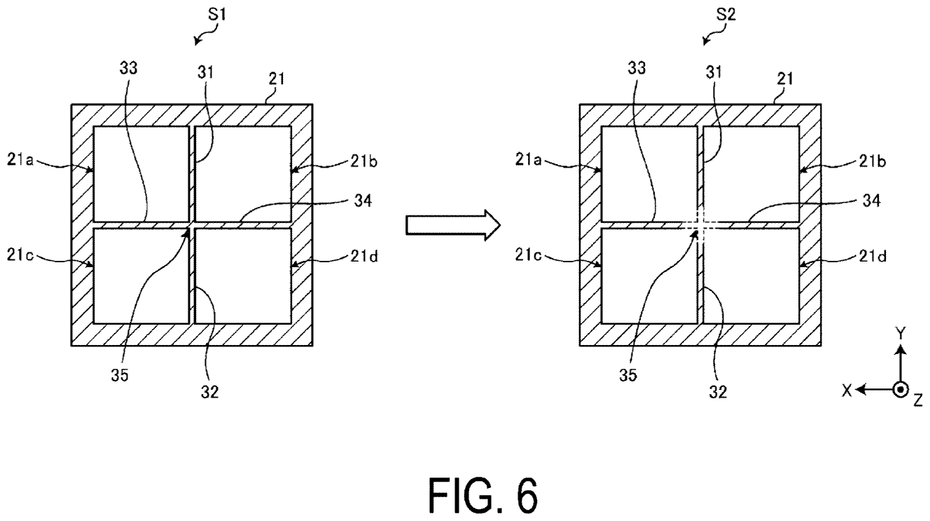

A configuration example of the reference conductor according to the first embodiment will be described with reference to FIG. 6. FIG. 6 is a diagram illustrating the configuration example of the reference conductor according to the first embodiment.

FIG. 6 illustrates the first reference conductor 21. The first reference conductor 21 includes a first conductor portion 31, a second conductor portion 32, a third conductor portion 33, and a fourth conductor portion 34 on its inner periphery.

The first conductor portion 31 protrudes in the −X direction from the central portion on the top side of the inner periphery of the first reference conductor 21. The second conductor portion 32 protrudes in the +X direction from the central portion on the bottom side of the inner periphery of the first reference conductor 21. The third conductor portion 33 protrudes in the +Y direction from the central portion on the left side of the inner periphery of the first reference conductor 21. The fourth conductor portion 34 protrudes in the −Y direction from the central portion on the right side of the inner periphery of the first reference conductor 21.

The first conductor portion 31, the second conductor portion 32, the third conductor portion 33, and the fourth conductor portion 34 are connected to each other by a connecting portion 35.

As illustrated in FIG. 6, the connecting portion 35 is configured to be switchable between a state in which the first conductor portion 31, the second conductor portion 32, the third conductor portion 33, and the fourth conductor portion 34 are short-circuited (step S1) and a state in which the first conductor portion 31, the second conductor portion 32, the third conductor portion 33, and the fourth conductor portion 34 are open-circuited (step S2) under the control of the controller 100.

The connecting portion 35 is a switch element that switches on/off the electrical connection. The controller 100 switches on/off the connecting portion 35. The connecting portion 35 can be constituted by, for example, a P-intrinsic-N (PIN) diode. In this case, the controller 100 can switch between the state in which the first conductor portion 31, the second conductor portion 32, the third conductor portion 33, and the fourth conductor portion 34 are short-circuited and the state in which they are open-circuited by controlling the voltage applied to the connecting portion 35. The connecting portion 35 is not limited to a PIN diode, and may be another electronic switch, for example. The connecting portion 35 is not limited to an electronic switch, and may be a mechanical switch, for example.

The first reference conductor 21 functions as a resonator when the connecting portion 35 is in an open-circuited state. Specifically, in the first reference conductor 21, when the connecting portion 35 is in an open-circuited state, the first conductor portion 31 to the fourth conductor portion 34 serve as a resonator. The first conductor portion 31 to the fourth conductor portion 34 are λ/4 resonators, where 2 is the wavelength of radio waves received by the unit structure 10. That is, the first reference conductor 21 is switched to the λ/4 resonator when the first conductor portion 31 to the fourth conductor portion 34 are in an open-circuited state.

That is, the controller 100 can increase the number of resonators included in the unit structure 10 by bringing the first conductor portion 31 to the fourth conductor portion 34 into the open-circuited state in the first reference conductor 21.

In the first embodiment, an example has been described in which the first reference conductor 21 is switched to a resonator; however, the present disclosure is not limited to this example. In the present disclosure, the second reference conductor 22 and the third reference conductor 23 may be configured to be switchable to a resonator by forming the second reference conductor 22 and the third reference conductor 23 in the same manner as and/or a similar manner to the first reference conductor 21.

### Configuration Example of Resonator

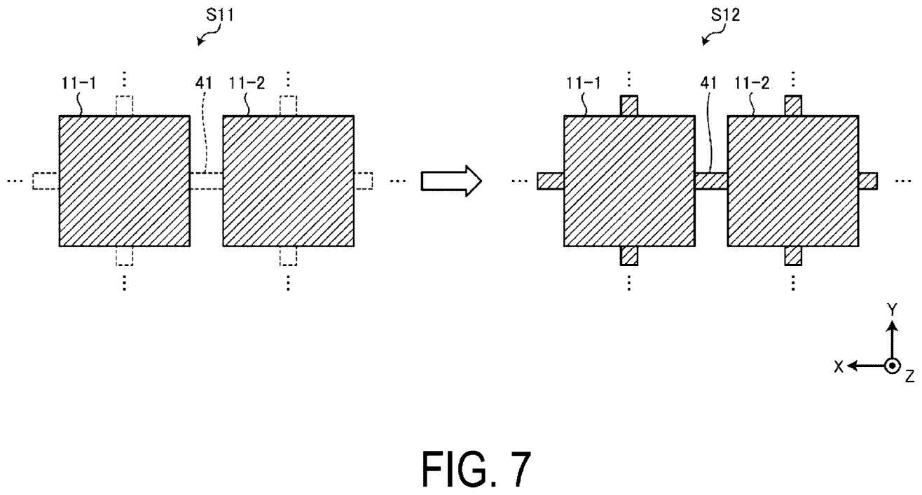

A configuration example of the resonator according to the first embodiment will be described with reference to FIG. 7. FIG. 7 is a diagram illustrating a configuration example of the resonator according to the first embodiment.

FIG. 7 illustrates a first resonator 11-1 and a first resonator 11-2 adjacent to each other in the radio wave control plate 1.

As illustrated in FIG. 7, in the first embodiment, the first resonators 11 connected to each other by a connecting portion 41. In the example illustrated in FIG. 7, the connecting portion 41 is configured to be switchable between a state in which the first resonator 11-1 and the first resonator 11-2 are open-circuited (step S11) and a state in which the first resonator 11-1 and the first resonator 11-2 are short-circuited (step S12) under the control of the controller 100.

The connecting portion 41 is a switch element that switches on/off the electrical connection. The controller 100 switches on/off the connecting portion 41. The connecting portion 41 can be constituted by, for example, a PIN diode. The controller 100 can switch between the state in which the first resonator 11-1 and the first resonator 11-2 are open-circuited and the state in which they are short-circuited by controlling the voltage applied to the connecting portion 41. The connecting portion 41 is not limited to a PIN diode, and may be another electronic switch, for example. The connecting portion 41 is not limited to an electronic switch, and may be a mechanical switch, for example.

Each of the first resonators 11 included in the first radio wave control plate 1 serves as a λ/2 resonator. The first resonators 11 are connected to each other by the connecting portion 41, and thus the first resonators 11 can be regarded as a single integrated conductor plate. Accordingly, the first resonators 11 are connected to each other by the connecting portion 41, and thus can be regarded as a reference conductor (ground conductor). That is, each of the first resonators 11 is configured to be switchable from a resonator to a reference conductor by being connected by the connecting portion 41.

That is, the controller 100 can reduce the number of resonators included in the unit structure 10 by connecting the first resonators 11 of the respective unit structures 10 arrayed on the radio wave control plate 1 by the connecting portion 41.

In the first embodiment, an example has been described in which the first resonator 11 is switched to the reference conductor; however, the present disclosure is not limited to this example. In the present disclosure, the second resonator 12, the third resonator 13, and the fourth resonator 14 may be configured to be switchable to the reference conductor.

### Reflection Characteristics and Transmission Characteristics

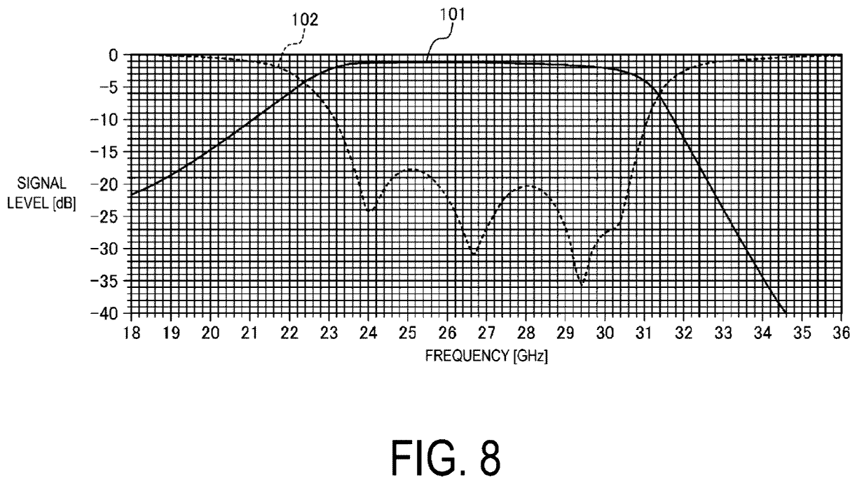

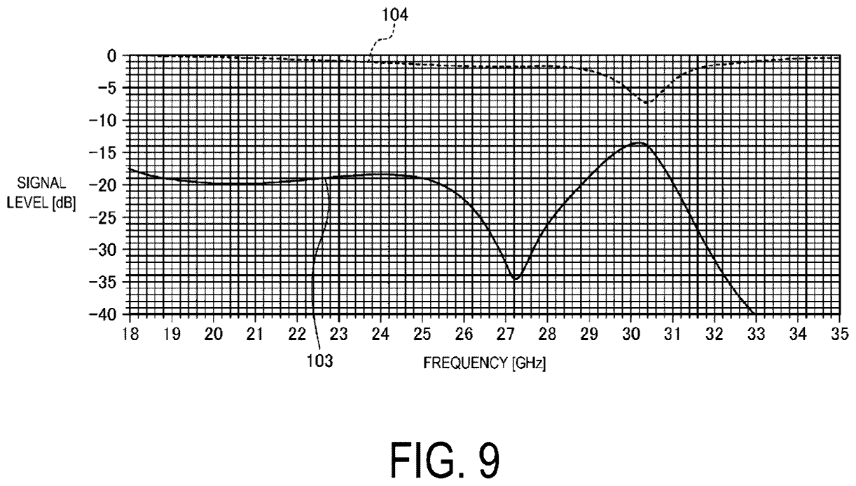

Reflection characteristics and transmission characteristics of the unit structure according to the first embodiment will be described with reference to FIGS. 8 and 9. FIG. 8 is a diagram showing reflection characteristics and transmission characteristics of the unit structure when a connecting portion of the first reference conductor of the unit structure according to the first embodiment is in a short-circuited state. FIG. 9 is a diagram showing reflection characteristics and transmission characteristics of the unit structure when the connecting portion of the first reference conductor of the unit structure according to the first embodiment is in an open-circuited state.

In FIG. 8, the horizontal axis represents frequency [gigahertz (GHz)] and the vertical axis represents signal level [decibel (dB)]. A waveform 101 indicates a signal level of a transmitted wave having been transmitted through the unit structure 10. A waveform 102 indicates a signal level of a reflected wave reflected by the unit structure 10. As indicated by the waveform 101, the unit structure 10 is configured to transmit radio waves in a band of about 23 [GHz] to 31 [GHz] when the connecting portion 35 of the first reference conductor 21 is in a short-circuited state.

In FIG. 9, the horizontal axis represents frequency [GHz], and the vertical axis represents signal level [dB]. A waveform 103 indicates a signal level of the transmitted wave having been transmitted through the unit structure 10. A waveform 104 indicates a signal level of the reflected wave reflected by the unit structure 10. As indicated by the waveform 103 and the waveform 104, the unit structure 10 is configured to reflect radio waves in a band from about 23 [GHz] to 31 [GHz] when the connecting portion 35 of the first reference conductor 21 is in an open-circuited state.

As shown in FIGS. 8 and 9, the unit structure 10 can transmit or reflect radio waves in a band of about 23 [GHz] to 31 [GHz] by switching the connecting portion 35 of the first reference conductor 21 between a short-circuited state and an open-circuited state.

As described above, the first embodiment is configured such that the number of resonators included in the unit structure can be changed. Thereby, the first embodiment can switch the unit structure between reflection and transmission.

### Second Embodiment

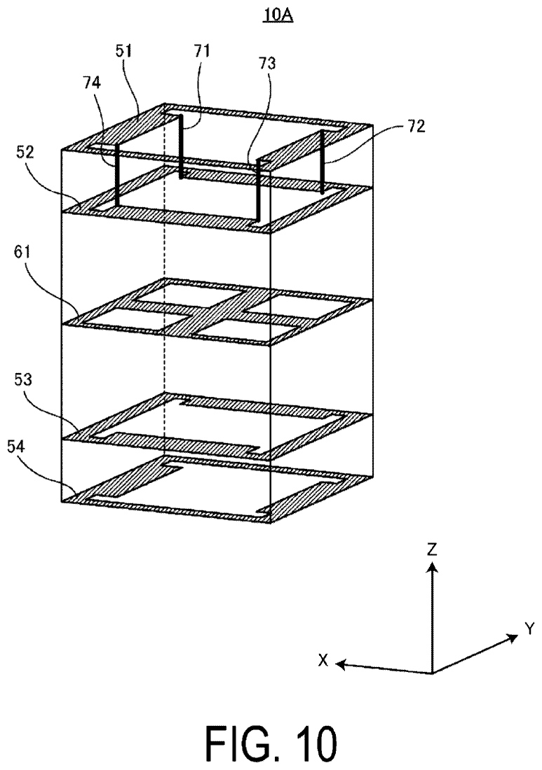

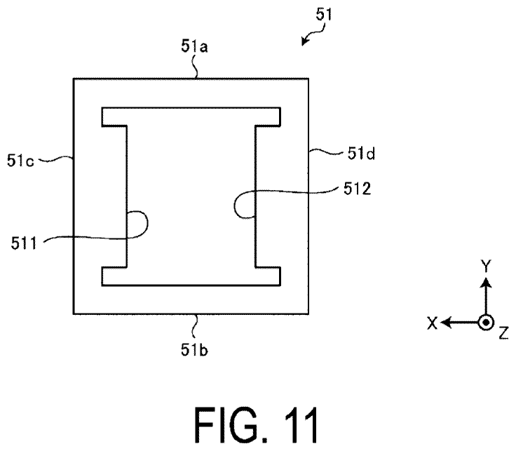

A configuration example of a unit structure according to a second embodiment will be described with reference to FIG. 10. FIG. 10 is a diagram illustrating the configuration example of the unit structure according to the second embodiment.

As illustrated in FIG. 10, a unit structure 10A includes a first resonator 51, a second resonator 52, a third resonator 53, a fourth resonator 54, and a reference conductor 61. The unit structure 10A has a five-layer structure in which five layers of conductors are stacked. In the unit structure 10A, the fourth resonator 54, the third resonator 53, the reference conductor 61, the second resonator 52, and the first resonator 51 are stacked in this order.

The first resonator 51 is formed in the uppermost layer. The first resonator 51 is made of a conductor. The first resonator 51 extends on the XY plane. FIG. 11 is a diagram illustrating a configuration example of a resonator according to the second embodiment.

As illustrated in FIG. 11, the first resonator 51 is formed in a rectangular frame shape. The first resonator 51 includes a protruding portion 511 and a protruding portion 512. The first resonator 51 includes two protruding portions.

The protruding portion 511 is provided on a side portion 51c of the first resonator 51 parallel to the Y-axis. The protruding portion 511 is provided so as to protrude inward (in the −X direction) from the side portion 51c. A clearance is formed between the protruding portion 511 and a side portion 51a. A clearance is formed between the protruding portion 511 and a side portion 51b. That is, the protruding portion 511 is provided so as to be magnetically or capacitively connected to the side portion 51a and the side portion 51b.

The protruding portion 512 is provided on a side portion 51d of the first resonator 51 parallel to the Y-axis. The protruding portion 512 is provided so as to protrude inward (in the +X direction) from the side portion 51d. A clearance is formed between the protruding portion 512 and the side portion 51a. A clearance is formed between the protruding portion 512 and the side portion 51b. That is, the protruding portion 512 is provided so as to be magnetically or capacitively connected to the side portion 51a and the side portion 51d.

The protruding portion 511 and the protruding portion 512 are λ/4 resonators. The first resonator 51 includes the protruding portion 511 and the protruding portion 512, and is thus configured to serve as a λ/4 resonator.

The second resonator 52 is formed in a layer immediately below the first resonator 51. The second resonator 52 is made of a conductor. The second resonator 52 extends on the XY plane. The second resonator 52 has the same shape as the first resonator 51. The second resonator 52 is disposed in a state of being rotated by 90 degrees on the XY plane with respect to the first resonator 51. That is, in the second resonator 52, two protruding portions are provided on the sides parallel to the X-axis. The first resonator 51 and the second resonator 52 are disposed in a state of being rotated by 90 degrees from each other on the XY plane. Thus, when viewed from one of the resonators, the other appears to be the ground.

The reference conductor 61 is formed in a layer immediately below the second resonator 52. Since the reference conductor 61 has the same structure as the first reference conductor 21 illustrated in FIG. 4, a description of the structure is omitted. The reference conductor 61 is a conductor for adjusting the coupling between the first resonator 51 or the second resonator 52 and the third resonator 53 or the fourth resonator 54.

The third resonator 53 is formed in a layer immediately below the reference conductor 61. The third resonator 53 is made of a conductor. The third resonator 53 has the same shape as the first resonator 51. The third resonator 53 is disposed in the same orientation as the second resonator 52.

The fourth resonator 54 is formed in a layer immediately below the third resonator 53. The fourth resonator 54 is made of a conductor. The fourth resonator 54 has the same shape as the first resonator 51. The fourth resonator 54 is disposed in the same orientation as the first resonator 51. The fourth resonator 54 is disposed in a state of being rotated by 90 degrees on the XY plane with respect to the third resonator 53. That is, the third resonator 53 and the fourth resonator 54 are disposed in a state of being rotated by 90 degrees from each other on the XY plane. Thus, when viewed from one of the resonators, the other appears to be the ground.

In the second embodiment, the unit structure 10A is configured to be switchable between reflection and transmission by short-circuiting or open-circuiting conductors formed in different layers. The unit structure 10A includes a connecting portion 71, a connecting portion 72, a connecting portion 73, and a connecting portion 74 connecting the first resonator 51 and the second resonator 52. The connecting portion 71 to the connecting portion 74 are provided between the first resonator 51 and the second resonator 52.

The connecting portion 71 has one end connected to the protruding portion 511 of the first resonator 51, and the other end connected to the protruding portion 511 of the second resonator 52.

The connecting portion 72 has one end connected to the protruding portion 512 of the first resonator 51, and the other end connected to the protruding portion 511 of the second resonator 52.

The connecting portion 73 has one end connected to the protruding portion 512 of the first resonator 51, and the other end connected to the protruding portion 512 of the second resonator 52.

The connecting portion 74 has one end connected to the protruding portion 511 of the first resonator 51, and the other end connected to the protruding portion 512 of the second resonator 52.

The connecting portions 71 to 74 are switch elements that switch on/off the electrical connection. The controller 100 switches on/off the connecting portions 71 to 74. The connecting portions 71 to 74 can be constituted by, for example, PIN diodes. The controller 100 can switch between a state in which the first resonator 51 and the second resonator 52 are open-circuited and a state in which they are short-circuited by controlling the voltages to be applied to the connecting portion 71 to the connecting portion 74. The connecting portions 71 to 74 are not limited to PIN diodes, and may be, for example, other electronic switches. The connecting portion 41 is not limited to an electronic switch, and may be a mechanical switch, for example.

In the example illustrated in FIG. 10, the connecting portion 71 to the connecting portion 74 are described as being provided between the first resonator 51 and the second resonator 52; however, the present disclosure is not limited thereto. The connecting portions 71 to 74 may be provided between the third resonator 53 and the fourth resonator 54. In this case, the connecting portions 71 to 74 switch between a state in which the third resonator 53 and the fourth resonator 54 are open-circuited and a state in which the third resonator 53 and the fourth resonator 54 are connected.

### Reflection Characteristics and Transmission Characteristics

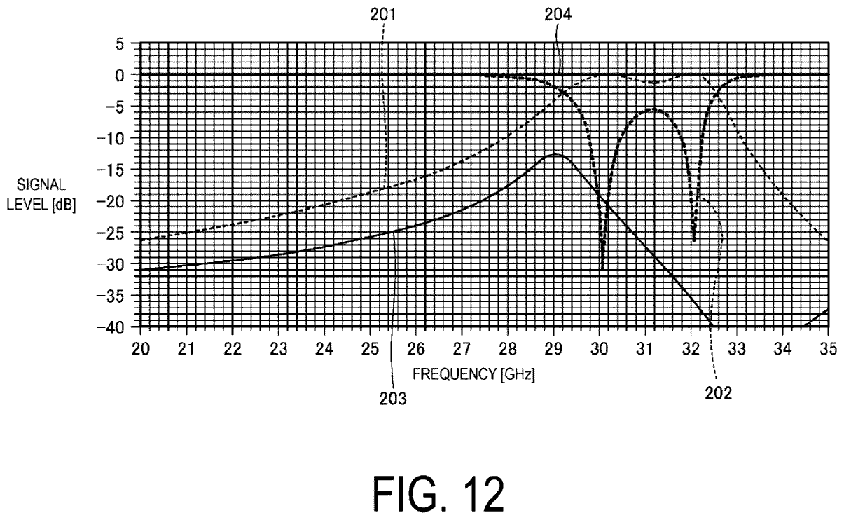

Reflection characteristics and transmission characteristics of the unit structure according to the second embodiment will be described with reference to FIG. 12. FIG. 12 is a diagram showing reflection characteristics and transmission characteristics of the unit structure according to the second embodiment.

In FIG. 12, the horizontal axis represents frequency [GHz], and the vertical axis represents signal level [dB]. A waveform 201 indicates transmission characteristics of the unit structure 10A when the first resonator 51 and the second resonator 52 are in an open-circuited state. A waveform 202 indicates reflection characteristics of the unit structure 10A when the first resonator 51 and the second resonator 52 are in the open-circuited state. A waveform 203 indicates transmission characteristics of the unit structure 10A when the first resonator 51 and the second resonator 52 are in a short-circuited state. A waveform 204 indicates reflection characteristics of the unit structure 10A when the first resonator 51 and the second resonator 52 are in a short-circuited state.

As indicated by the waveform 201 and the waveform 202, the unit structure 10A is configured to transmit radio waves in a band of about 29.5 [GHz] to 32.5 [GHz] when the connecting portion 71 to the connecting portion 74 are in an open-circuited state.

As indicated by the waveform 203 and the waveform 204, the unit structure 10A is configured to reflect radio waves in a band of about 29.5 [GHz] to 32.5 [GHz] when the connecting portions 71 to 74 are in a short-circuited state.

As shown in FIG. 12, the unit structure 10A can transmit or reflect radio waves in a band of about 29.5 [GHz] to 32.5 [GHz] by switching the first resonator 51 and the second resonator 52 between a short-circuited state and an open-circuited state.

As described above, the second embodiment is configured such that the number of resonators included in the unit structure can be changed. Thereby, the second embodiment can switch between reflection and transmission for the unit structure.

Embodiments of the present disclosure have been described above, but the present disclosure is not limited by the contents of the embodiments. Constituent elements described above include those that can be easily assumed by a person skilled in the art, those that are substantially identical to the constituent elements, and those within a so-called range of equivalency. The constituent elements described above can be combined as appropriate. Various omissions, substitutions, or modifications of the constituent elements can be made without departing from the spirit of the above-described embodiments.

### Reference Signs

1 Radio wave control plate
2 Substrate
10, 10A, 10a, 10b, 10c, 10d Unit structure
11, 51 First resonator
12, 52 Second resonator
13, 53 Third resonator
14, 54 Fourth resonator
21 First reference conductor
22 Second reference conductor
23 Third reference conductor
31 First conductor portion
32 Second conductor portion
33 Third conductor portion
34 Fourth conductor portion
35,41,71,72,73,74 connecting portion
61 Reference conductor
100 Controller

1. A radio wave control plate comprising:
a plurality of unit structures arrayed in a first planar direction,
wherein each of the unit structures comprises:
a plurality of resonators extending in the first planar direction;
a coupling conductor configured to adjust a coupling coefficient between the plurality of resonators; and
a connecting portion configured to change a structure corresponding to a coupling matrix of the unit structure.

2. The radio wave control plate according to claim 1,
wherein the connecting portion changes the number of the resonators included in the unit structure.

3. The radio wave control plate according to claim 2,
wherein the coupling conductor comprises a plurality of electrically conductive portions, and
the connecting portion changes the number of resonators included in the unit structure by short-circuiting or open-circuiting the plurality of electrically conductive portions.

4. The radio wave control plate according to claim 2,
wherein the connecting portion changes the number of the resonators included in the unit structure by short-circuiting or open-circuiting the resonators formed in the same layer of the unit structure and the unit structure adjacent to the unit structure.

5. The radio wave control plate according to claim 2,
wherein the connecting portion changes the number of the resonators included in the unit structure by short-circuiting or open-circuiting the resonators or the coupling conductors formed in different layers of the unit structure.

6. The radio wave control plate according to claim
wherein the resonators are λ/2 resonators or λ/4 resonators.

7. The radio wave control plate according to claim 3,
wherein the connecting portion is a switch element configured to switch on/off electrical connection.

8. The radio wave control plate according to claim 7,
wherein the switch element is a PIN diode.
